(19) United States
(12) Patent Application Publication
(10) Pub. No.: US 2020/0062068 A1
(43) Pub. Date: Feb. 27, 2020

(54) MAGNETIC INDUCTION ACTUATOR SUSPENSION SYSTEM

(71) Applicant: GM GLOBAL TECHNOLOGY OPERATIONS LLC, Detroit, MI (US)

(72) Inventors: KLAUS TRANGBAEK, EIN VERED (IL); DOR GABAY, San Jose, CA (US)

(73) Assignee: GM GLOBAL TECHNOLOGY OPERATIONS LLC, Detroit, MI (US)

(21) Appl. No.: 16/109,866

(22) Filed: Aug. 23, 2018

(51) Int. Cl. B60G 17/015; B60G 17/06; B60G 17/0165

(52) U.S. Cl. CPC B60G 17/0157; B60G 17/06; B60G 17/0165; B60G 2500/10; B60G 2202/20; B60G 2202/422; B60G 2400/10

(57) ABSTRACT

A suspension system includes a first and second mass and an actuator connected with the first mass and with the second mass and configured to influence a relative movement between the first mass and the second mass. The actuator includes a tube, and a magnetic assembly disposed in the tube. The actuator is configured to generate a force between the magnetic assembly and the tube as a result of the relative movement between the two. A motor is configured to rotate the magnetic assembly relative to the tube to vary the force in a velocity-dependent relationship. The actuator may generate forces to resist or assist motion between the first and second masses.

### INTRODUCTION

The technical field generally relates to the field of suspension systems and more specifically, to active suspension systems providing force generation between the sprung and unsprung masses of vehicles.

Vehicles and other equipment and machinery apparatus include suspension systems that help dampen oscillations for purposes such as to provide stability, a more comfortable ride and preferred handling characteristics. A vehicle suspension system typically includes dampers and springs that act between the sprung (vehicle body) and unsprung (wheel assembly) masses.

Suspension dampers typically consist of direct double-acting telescopic hydraulic passive dampers. They are generally referred to as either a shock absorber, which is separate from the spring or a strut, which is integrated with the spring and provides lateral support. A primary purpose of the damper is to dampen oscillations of the vehicle body relative to the wheel assembly, and those of the springs that extend between the two. Dampers are often hydraulic devices using oil to restrict movement of a piston within a cylindrical tube. With certain types of vehicles, it is desirable to provide active or semi-active control of the suspension system to adapt to driving conditions. An active damper's control system often varies the orifice sizes of valves in the damper's piston to provide different damping levels depending on encountered road conditions or ride and handling preferences. There are generally limitations in the range of performance options available, and delivering real-time response to instantaneous road inputs is a challenge.

Accordingly, it is desirable to provide an economical and fast responding suspension system that delivers performance characteristics that closely match instantaneous road inputs. Furthermore, other desirable features and characteristics of the present invention will become apparent from the subsequent detailed description and the appended claims, taken in conjunction with the accompanying drawings.

### SUMMARY

In a number of embodiments, a suspension system includes a first and second mass and an actuator connected with the first mass and with the second mass and configured to influence a relative movement between the first mass and the second mass. The actuator includes a tube, and a magnetic assembly disposed in the tube. The actuator is configured to generate a force between the magnetic assembly and the tube as a result of the relative movement between the two. A motor is configured to rotate the magnetic assembly relative to the tube to vary the force in a velocity-dependent relationship.

In additional embodiments, a shaft extends into the tube, and the motor is disposed outside the tube and is connected with the magnetic assembly through the shaft.

In additional embodiments, the magnetic assembly includes plural magnetic elements configured with polarities in alternating relation.

In additional embodiments, the magnetic element is configured to generate the force from a first force component that results from a longitudinal movement of the magnetic element relative to the tube and selectively, from a second force component that results from a rotational movement of the magnetic element relative to the tube.

In additional embodiments, the first mass includes a vehicle body, the second mass includes a wheel, the tube is connected to move with the second mass, and the magnetic element is connected to move with the first mass.

In additional embodiments, a spring suspends the first mass on the tube.

In additional embodiments, the actuator is configured to generate the force in relation to a velocity of the relative movement independent of a position of the magnetic assembly within the tube.

In additional embodiments, the magnetic assembly generates a magnetic field that is the sole source of damping force of the actuator.

In additional embodiments, a controller is configured to: monitor a sensor to obtain an acceleration of the first mass; determine, from the acceleration, a desired force for the actuator; and control delivery of current to the motor to rotate the magnetic assembly at a velocity that generates the desired force.

In additional embodiments, the actuator is configured to generate a first force at a first velocity of the magnetic assembly relative to the tube and a second force at a second velocity of the magnetic assembly relative to the tube, wherein the first velocity is slower than the second velocity and the first force has a lower magnitude than the second force.

In additional embodiments, a first guide is disposed in the tube on a first side of the magnetic assembly, and a second guide is disposed in the tube on a second side of the magnetic assembly. The first and second guides are configured to center the magnetic assembly in the tube.

In other embodiments, a suspension system includes an unsprung mass, a sprung mass, and an actuator connected with the unsprung mass and with the sprung mass and configured to generate force in response to a relative movement between the sprung mass and the unsprung mass. The actuator includes a tube comprising an electrically conductive material, and a magnetic assembly disposed in the tube. The actuator is configured to generate the force between the magnetic assembly and the tube in relation to a velocity of the relative movement. A motor that has a rotor is connected with the magnetic assembly and is configured to rotate the magnetic assembly relative to the tube.

In additional embodiments, the magnetic assembly includes plural magnetic elements configured in spirals that encircle the magnetic assembly to create alternate adjacent helixes with opposite polarities.

In additional embodiments, the magnetic element is configured to generate the force from a first force component that results from a longitudinal movement of the magnetic element relative to the tube and selectively from a second force component that results from a rotational movement of the magnetic element relative to the tube. The first force component varies in relation to a first velocity of the longitudinal movement and the second force component varies in relation to a second velocity of the rotational movement.

In additional embodiments, the sprung mass includes a vehicle body, and the unsprung mass includes a wheel and a control arm. The magnetic element is connected to the vehicle body to move with the sprung mass, and the tube is connected to the control arm to move with the unsprung mass.

In other embodiments, a vehicle suspension system includes a sprung mass that includes a body of the vehicle and an unsprung mass that includes a wheel of the vehicle. A spring suspends the sprung mass on the unsprung mass. An actuator is connected with the sprung mass and with the unsprung mass and is configured to influence a relative movement between the sprung and unsprung masses. The actuator includes a tube fixed to move with the unsprung mass. A magnetic assembly is disposed in the tube and is fixed to move with the sprung mass. The actuator is configured to generate a force between the magnetic assembly and the tube as a result of the relative movement between the two. A motor has a rotor connected with the magnetic assembly to selectively rotate the magnetic assembly relative to the tube to vary a magnitude of the force.

### BRIEF DESCRIPTION OF THE DRAWINGS

The present disclosure will hereinafter be described in conjunction with the following drawing figures, wherein like numerals denote like elements, and wherein:

FIG. 1 is a functional block diagram of a vehicle, namely an automobile that includes a suspension system, in accordance with exemplary embodiments;

FIG. 2 is a schematic illustration of a corner assembly of the suspension system of the vehicle of FIG. 1, in accordance with exemplary embodiments;

FIG. 3 illustrates an actuator assembly of the corner assembly of FIG. 2, in accordance with exemplary embodiments;

FIG. 4 is a schematic illustration of a corner assembly of the suspension system of the vehicle of FIG. 1, in accordance with exemplary embodiments;

FIG. 5 is a schematic illustration of a part of the actuator of the corner assembly FIG. 3, in accordance with exemplary embodiments;

FIG. 6 illustrates a part of a magnetic assembly of the actuator of FIG. 5, in accordance with exemplary embodiments;

FIGS. 7-8 are reference illustrations of the actuator assembly of FIG. 3, in accordance with exemplary embodiments;

FIG. 9 is a schematic illustration of a portion of an actuator tube, in accordance with exemplary embodiments;

FIGS. 10 and 11 illustrate a part of a magnetic assembly of the actuator of FIG. 5, in accordance with exemplary embodiments;

FIG. 12 is a graph of longitudinal force in Newtons versus linear velocity in meters per second for the actuator of FIG. 3, in accordance with exemplary embodiments;

FIG. 13 is a graph of longitudinal force in Newtons versus rotational velocity in revolutions per minute for the actuator of FIG. 3, in accordance with exemplary embodiments;

FIG. 14 illustrates a control scheme for the suspension system of the vehicle of FIG. 1, in accordance with exemplary embodiments;

FIG. 15 depicts a road input on the suspension system of FIG. 1 in millimeters versus time, in accordance with exemplary embodiments; and

FIG. 16 depicts a response of the suspension system of FIG. 1 in radians per second versus time, to the road input of FIG. 12, in accordance with exemplary embodiments.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description.

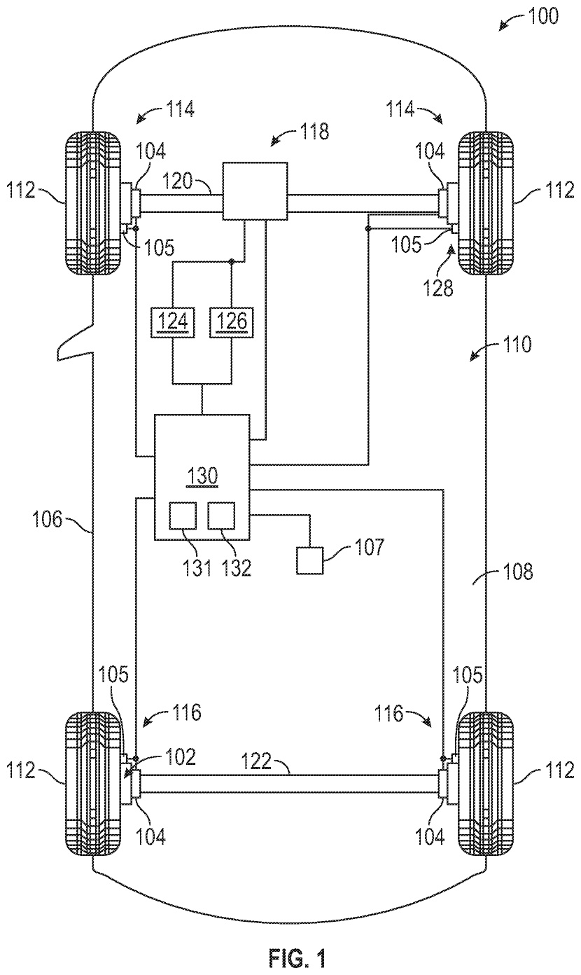

FIG. 1 illustrates a vehicle 100 having a suspension system 102, in accordance with exemplary embodiments. As described in greater detail below, in various embodiments, the suspension system 102 includes one or more actuator assemblies 104 that are active and electrically operated to provide influence over motion induced forces. As shown in FIG. 1, in various embodiments the suspension system 102 is implemented in connection with four corners of the vehicle 100. In certain other embodiments, the suspension system 102 is implemented in connection with less than all of the vehicle's wheels. In other embodiments, the suspension system 102 is implemented in non-vehicle applications such as stationary machinery or equipment, or other suspended apparatus.

As depicted in FIG. 1, in certain embodiments, the vehicle 100 comprises an automobile. It will be appreciated that the suspension system 102 described herein may be implemented in any number of different types of vehicles and/or platforms. For example, in various embodiments, the vehicle 100 may comprise any number of different types of automobiles (e.g., taxi cabs, vehicle fleets, buses, sedans, wagons, trucks, sport utility vehicles, and other automobiles), other types of vehicles (e.g., off-road vehicles, locomotives, aircraft, and other vehicles), and/or other mobile or stationary platforms, and/or components thereof.

In various embodiments, the vehicle 100 includes a body 106 that is integrated with, or arranged on, a chassis 108. The body 106 substantially encloses other components of the vehicle 100 including the passenger compartment 110. The vehicle 100 also includes a plurality of wheels 112. The wheels 112 are each rotationally coupled to the body 106 near a respective corner of the body 106 through a suspension system 102 to facilitate movement of the vehicle 100 relative to the wheels 112. The wheels 112 form a part of corner assemblies 114, 116 that comprise the unsprung masses of the vehicle 100 and that generally follow the road on which the vehicle 100 operates including the road's irregularities. In one embodiment, the vehicle 100 includes four wheels 112, although this may vary in other embodiments (for example for trucks and certain other vehicles). The corner assemblies 114 at the front of the vehicle 100 may differ from the corner assemblies 116 at the rear of the vehicle 100, or may be the same. For example, a solid rear axle or a fully independent rear suspension may be provided.

A propulsion system 118 may be mounted on the chassis 108, and drives some or all of the wheels 112, for example via axles 120, 122. In certain exemplary embodiments, the propulsion system 118 comprises an internal combustion engine and/or an electric motor/generator, coupled with a transmission thereof. As shown, the vehicle 100 has various additional vehicle systems that generally include an accelerator system 124, a steering system 126, and a brake system 128. The accelerator system 124 may respond to driver inputs, or may respond to a controller 130. The accelerator system 124 may include a throttle, such as with an internal combustion engine, electric control, such as with an electric vehicle, or another mechanism to control acceleration.

The controller 130 comprises a computer system. In the depicted embodiment, the computer system of the controller 130 includes a processor 131, and memory 132. The processor 131 performs the computation and control functions of the controller 130, and may comprise any type of processor or multiple processors, single integrated circuits such as a microprocessor, or any suitable number of integrated circuit devices and/or circuit boards working in cooperation to accomplish the functions of a processing unit. During operation, the processor 131 executes one or more programs, such as for the processes described below, which may be contained within the memory 132 and, as such, controls the general operation of the controller 130 and the computer system of the controller 130 in executing the processes described herein. The memory 132 is any type of suitable memory. For example, the memory 132 may include various types of dynamic random access memory (DRAM) such as SDRAM, the various types of static RAM (SRAM), and the various types of non-volatile memory (PROM, EPROM, and flash), or another type. In certain examples, the memory 132 is located on and/or co-located on the same computer chip as the processor 131. In the depicted embodiment, the memory 132 stores the above-referenced program(s) along with stored data. It will similarly be appreciated that the computer system of the controller 130 may differ from the embodiment depicted in FIG. 1, for example the computer system of the controller 130 may be coupled to or may otherwise utilize one or more other computer systems and/or other control systems. The controller 130 is electrically coupled with various devices such as the actuators 104, and sensors 105, 107. The sensors 105 are provided as accelerometers at each of the corner assemblies 114, 116 for use as described below. In the current embodiment, the sensor(s) 107 are accelerometers mounted on the sprung mass of the body 106 near its center and may measure acceleration in three quantities, such as for yaw, pitch and roll. In other embodiments the accelerometers are included on the unsprung masses or on both the sprung and the unsprung masses.

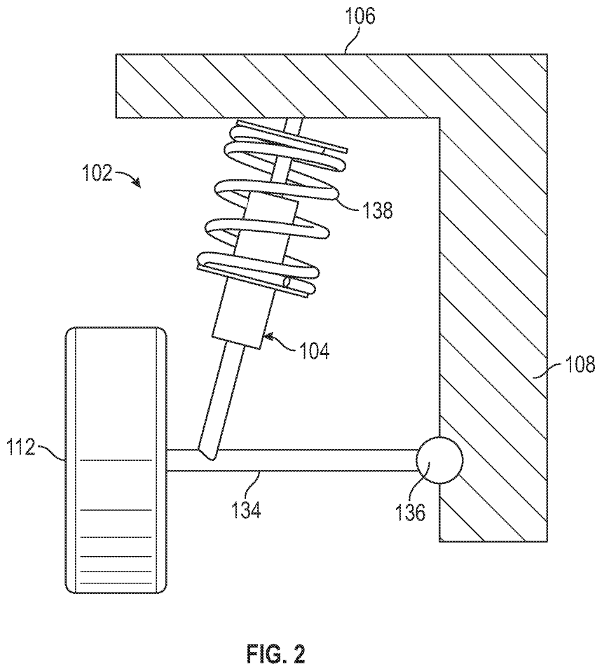

As depicted in FIG. 1 and noted above, the suspension system 102 includes the above-referenced actuators 104, such as at the corner assemblies 114. FIG. 2 shows a view of the suspension system 102 of the corner assemblies 114, along with various associated components, in accordance with exemplary embodiments. As depicted in FIG. 2, in various embodiments, the suspension system 102 includes a control arm 134 that connects the wheel 112 with the chassis 108 at a pivot point 136. As a result, the wheel is moveable up and down relative to the body 106 and the chassis 108, as the control arm 134 pivots about the pivot point 136. The actuator 104 has a lower connection with the control arm 134 and an upper connection with the body 106, each directly or indirectly, so that the actuator 104 extends or contracts when the wheel 112 moves relative to the body 106. In this embodiment, the actuator 104 includes an integral spring 138 that supports the body 106, through the actuator 104, on the control arm 134 and that allows oscillation therebetween.

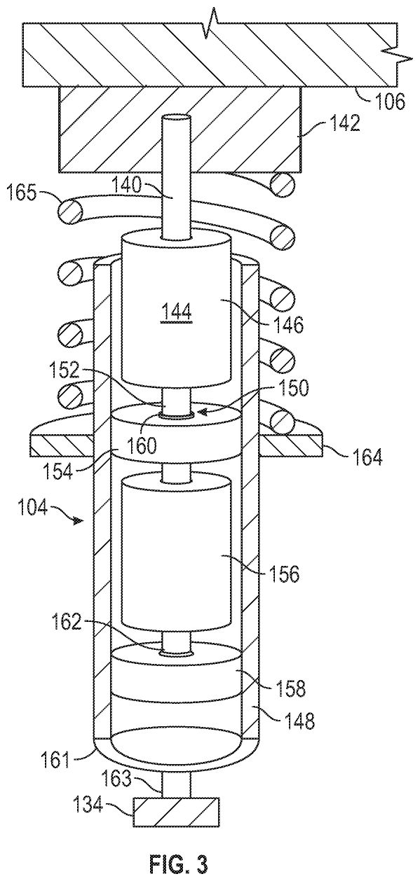

Referring to FIG. 3, one of the corner assemblies 114 is again depicted, with the actuator 104 shown partially sectioned. The actuator 104 includes a post 140 attached to the body 106 by a top mount 142. Accordingly, the post 140 is connected to move with the body 106, with some resiliency provided by the top mount 142. For example, the top mount 142 contains an elastomer in some embodiments. A motor 144 is attached to the post 140, and in this embodiment, is an electric motor that operates bi-directionally. In some embodiments the motor 144 is mounted out of the load path between the actuator 104 and the body 106. In other embodiments, the motor 144 carries the loads, such as through its case 146. The motor 144 includes the case 146 that fits within a tube 148 for movement therein. The rotor 150 of the motor 144 includes a shaft 152 extending from the case 146 through a top guide 154, a magnetic assembly 156 and a bottom guide 158. The guides 154, 158 are constructed as circular discs that fit closely within the tube 148 to guide the motor 144 and the magnetic assembly 156 through the tube and to maintain the magnetic assembly 156 centered in the tube 148. The guides 154, 158 are attached to move along the tube 148 with the shaft 152, such as by flared sections of the shaft or other means, and are provided with bearings 160, 162 respectively, so that they are not required to rotate with the rotor 150. The magnetic assembly 156 is fixed to the shaft 152 to rotate with the rotor 150 and to translate through the tube 148 with the motor 144. The tube 148 includes an end 161 connected to the control arm 134 by a post 163.

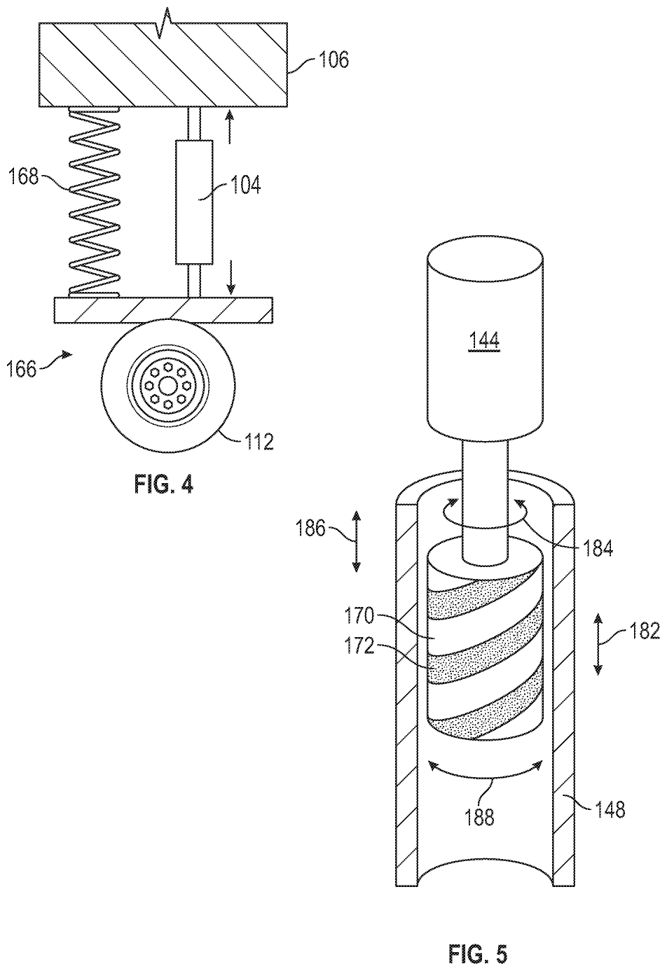

A spring 165 is compressed between the top mount 142 and a spring seat 164 fixed to the tube 148. The spring 165 suspends the body 106 on the tube 148 and therethrough on the control arm 134. The spring 165 oscillates as the body 106 moves relative to the wheel 112. Referring to FIG. 4, one of the corner assemblies 116 is depicted. The actuator 104 is connected between the body 106 and the unsprung mass 166, which includes the respective wheel 112. In this embodiment, the spring 168 extends from the body 106 to the unsprung mass 166 and is separate from the actuator 104. Otherwise, the actuator 104 is similar to that of the corner assemblies 114 as depicted in FIG. 3.

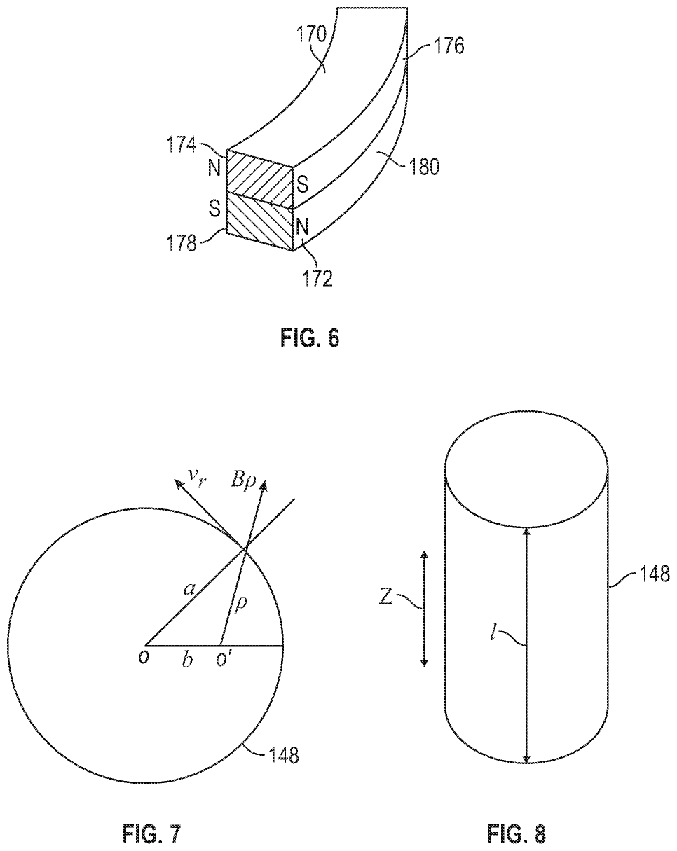

The actuators 104 generate force to control oscillations of the body 106 on the springs 138, 168 as the wheels 112 encounter variations in the surface of the roadway upon which the vehicle 100 travels. Referring to FIGS. 5 and 6, the magnetic assembly 156 includes magnetic elements 170, 172 that are configured as spiral elements that encircle the cylindrically shaped magnetic assembly 156 so as to create alternate adjacent helixes with opposite polarities. For example, the magnetic element 170 has an inner side 174 that has a North polarity, and an outer side 176 that has a South polarity. The adjacent magnetic element 172 has an inner side 178 that has a South polarity, and an outer side 180 that has a North polarity. The result is much like a magnetic screw where the magnetic assembly 156 acts against the fields of currents induced in tube 148. The tube 148 is made of a conductive material such as aluminum, copper, an alloy of either, steel, conductive polymer, or another conductive material. The magnetic elements 170, 172 comprise a permanent magnetic material and in the current embodiment are made of neodymium. As the magnetic assembly 156 moves within the tube 148, the alternating poles of the magnetic elements 170, 172 effect travelling fields that induce currents in the tube 148 that encircle the tube 148 and interact with the magnetic elements 170, 172. The result is that any movement of the magnetic elements 170, 172 generates a force on the magnetic assembly 156 and results in a motion influencing effect. Movement may occur in the form of longitudinal translation 182 of the magnetic assembly 156 within the tube 148 resulting from movement of the unsprung masses 166 relative to the body 106 and/or from rotation 184 of the magnetic assembly 156 within the tube 148 as effected by operation of the motor 144. As the speed of relative movement increases, the generated current and the resulting force increases. Accordingly, a rapid impact input such as that of a wheel 112 rolling over a bump generates rapid movement and a high force to counter the impact. Also, an increase in speed of the motor 144 generates rapid movement and increasingly higher force with increased rotational velocity. As a result, the actuator 104 is automatically responsive to variations in road inputs and is controllably responsive to provide added force to counter or otherwise influence inputs and/or to provide different ride quality characteristics. For example, the damping force may be increased or decreased by rotating the motor in the appropriate direction, and active force may be generated, including force in the direction of motion, thereby injecting power into the suspension. This unique velocity of movement-to-force relation avoids harshness in response that might otherwise be associated with inertia or other excessive response forces. In addition, the actuator 104 is never completely stiff but remains variably compliant in all operating conditions allowing movement of the magnetic assembly 156 within the tube 148 as tempered by the generated forces. For example, from a starting point of no movement, for an initial relative movement between the magnetic assembly 156 and the tube 148, the actuator 104 has a soft character and force increases as velocity increases. The forces generated are independent of the position of the magnetic assembly 156 within tube 148, since velocity of relative movement is the controlling factor for force generation.

In the current embodiment, longitudinal force 186 (F_{z}) with respect to rotational velocity 188 (vᵣ), such as generated by rotation of the magnetic assembly 156 by the motor 144, demonstrates a linear relationship:

$${F}_{z} ( {v}_{r} , {λ}_{d} ) = \frac{36 π σ τ {v}_{r} {μ}^{2}}{α {a}^{3}} \frac{1}{\sqrt{{( 2 π a )}^{2} + {λ}_{d}^{2}}} {\int }_{0}^{l} {[ G ( u , b ) ]}^{2} \partial u$$

where, μ is the dipole moment, σ is the electrical conductivity, and λ_{d} is the wavelength of the magnetic assembly 156, α is a first order correction term (α≈1.25) used for the internal magnetic field, a and b are lengths defined along the cross section of the cylinder (as specified in FIG. 7). The upper limit l is the length of the pipe as indicated in FIG. 8 along the z-axis (assumed to be large compared to radius). θ is the azimuthal angle of the cylinder, τ is the pipe thickness. The linear nature of the relationship simplifies control of the active aspects of the forces provided by the actuator 104.

In the foregoing equation, the integral of G(u, b) over the u=αz/a is the force factor:

$$G ( u , b ) = {\int }_{0}^{2 π} \frac{u [ 1 - ( b / a ) cos θ ]}{2 π [ 1 + {( b / a )}^{2} - 2 ( \frac{b}{a} ) cos θ + {u}^{2} ]} \partial θ$$

Also in the equation, the dipole moment μ is approximated as:

$$μ = \frac{25 \sqrt{5 {a}^{3}} {B}_{ρ , ma x}}{48}$$

Where, B_{p,max} is the maximum magnetic field along the radial direction of the magnetic assembly 156 and the tube 148, as indicated in FIG. 8. An approximation of B_{p,max} that is proportional to the moment parameter m is represented by:

$${B}_{ρ , ma x} = \frac{m}{4 {π ( a - b )}^{3}}$$

In addition to its active variability as a result of relative rotational velocity between the magnetic assembly 156 and the tube 148, the magnitude of the force generated between the magnetic assembly 156 and the tube 148 is also variable by changing the magnetic dipole moment μ, such as by changing the strength of the magnetic elements 170, 172.

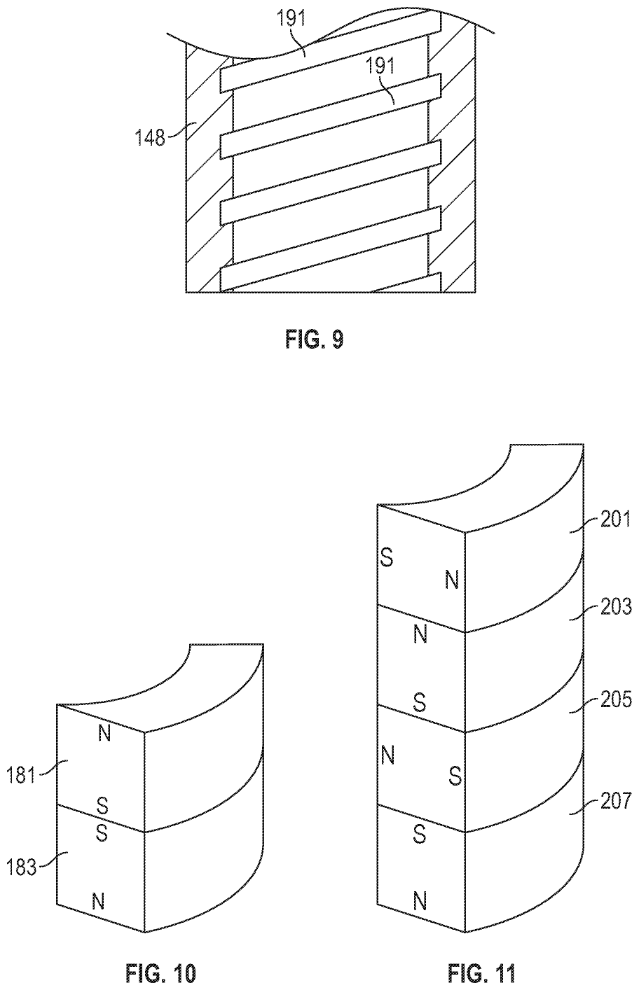

Optionally, as shown in FIG. 9, the interior of the tube 148 includes spiral grooves 191. The grooves 191 may be used to influence the magnetic field that is generated by relative movement of the magnetic assembly 156 relative to the tube 148, and to enhance the generated forces. Also optionally, the magnetic elements of the magnetic assembly 156 may be arranged in other configurations. For example, as shown in FIG. 10, adjacent magnetic elements 181, 183 are arranged with the South pole of magnetic element 181 positioned against the South pole of magnetic element 183. It will be understood that additional magnetic elements will be stacked with the North poles of adjacent elements positioned against each other and the South poles of adjacent elements positioned against each other. Also for example, as shown in FIG. 11, magnetic elements 201, 203, 205 and 207 of a larger stack of magnetic elements are arranged with the North and South poles configured in an array with every other magnetic element 201, 205 having the North-South poles disposed in a first direction and the interposed alternate magnetic elements 203, 207 having North-South poles disposed in a second direction that is oriented ninety degrees relative to the first direction. In addition, the magnetic elements 201, 205 have switched magnetic poles, and the magnetic elements 203, 207 have switched magnetic poles (e.g. a Hallbach array).

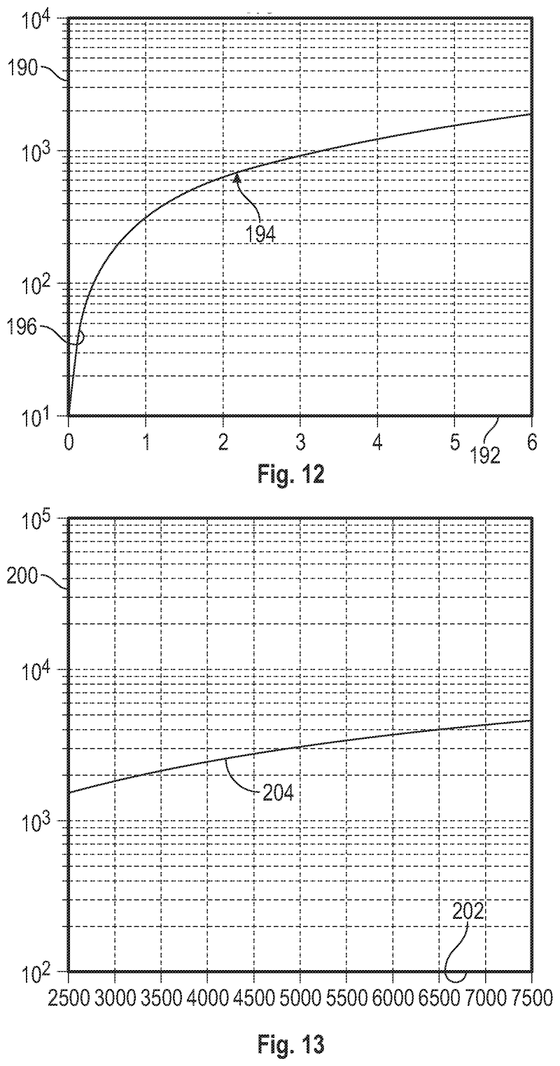

Reference is directed to FIGS. 12 and 13, which demonstrate the forces generated between the magnetic assembly 156 and the tube 148 as a longitudinal force component and as a rotational force component, respectively. FIG. 13 depicts longitudinal force in Newtons on the vertical axis 190 versus linear velocity of the magnetic assembly 156 within the tube 148 in meters per second along the horizontal axis 192. The curve 194 demonstrates that as longitudinal (translational) velocity of the magnetic assembly 156 relative to the tube 148 increases, the longitudinal force increases. In the segment 196 of the curve 194, longitudinal force increases at a very steep rate as linear velocity increases. The segment 196 demonstrates the favorable performance characteristics of the actuator 104 for use as a suspension damper since force rapidly increases in response to initial input. Initially, the magnetic assembly is moveable under a low force and as its speed increases, the force is generated very rapidly and increases with speed. Accordingly, the actuator 104 reacts quickly to impact inputs such as those encountered by a rapid rise or drop of a wheel 112 relative to the body 106. FIG. 13 depicts longitudinal force in Newtons on the vertical axis 200 versus rotational velocity of the magnetic assembly 156 within the tube 148 in revolutions per minute on the horizontal axis 202. The curve 204 demonstrates that as rotational velocity of the magnetic assembly 156 relative to the tube 148 increases, the longitudinal force on the magnetic assembly 156 increases. Accordingly, the actuator 104 reacts to rotational inputs generated by the motor 144 to provide variable damping rates, such as in active suspension applications.

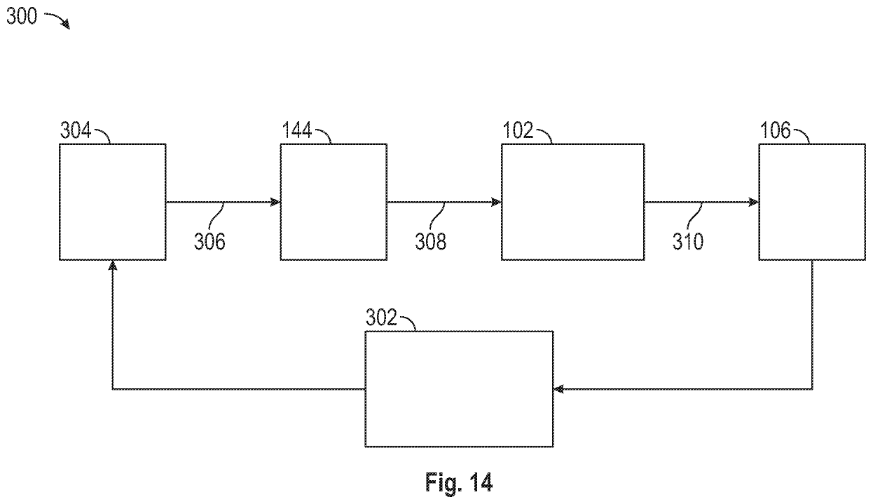

As depicted in FIG. 14, control of the actuator 104 for active damping or other force generation is relatively simple without a need to compensate for inertia and without a need for force inputs, which would otherwise require force transducers. In this embodiment, force level is controlled in relation to relative velocity between the sprung and unsprung masses. In one embodiment, relative velocity is derived from acceleration of the sprung mass so that the number of required sensors is minimized. It will be understood that the force level generated by longitudinal translation of the magnetic assembly 156 relative to the tube 148 is a factor of velocity, the magnetic properties of the magnetic elements 170, 172, the quantity of magnetic elements 170, 172, the conductive properties of the tube 148, and the physical dimensions of the magnetic assembly 156 and the tube 148. These are selected during development to provide force levels desired for the application. The force levels are then inherent to the design of the actuator 104. Those inherent force levels are then variable by operation of the electric motor 144. Accordingly, the process 300 provides passive response designed for the application, and controlled active response with variation in force levels for response to inputs and/or for variable levels of performance.

Taking effect of the rotationally variable force level effect, the controller 130 is configured to actively control the force level provided by the actuator 104. The process 300 provides for the controller 130 to monitor 302 the sensors 105, 107 for example, to measure acceleration of the unsprung masses 166, and the sprung mass of the body 106. At motion control block 304, the desired force for the actuator 104 to generate is determined by the controller 130. For example, the processor 131 obtains the unsprung mass acceleration from the sensor(s) 105, the sprung mass acceleration from the sensor(s) 107, calculates the displacement of the unsprung mass relative to the sprung masses, and from the two determines the desired force to be achieved by the actuator 104, such as for a damping effect. In some embodiments, the displacements of the unsprung masses relative to the sprung mass are calculated using the inputs from sensors 105 and the sensor(s) 107 such as using typical skyhook control. In some embodiments, the sensor(s) 105 are omitted and the displacement of the unsprung mass is an estimation derived from the sprung mass acceleration determined through the sensor(s) 107.

From the sensors 105 and/or 107, the controller 130 determines the desired force and its direction for each actuator 104 and delivers a velocity command or commands 306 to a drive circuit for the motor 144 that delivers the appropriate current 308 level for the desired rotational speed of the motor(s) 144. After calculating the desired force(s), in this embodiment the motion control block 304 determines, such as through lookup tables, the corresponding current level for the motor 144 to deliver the desired force. The current 308 is delivered to the suspension system 102, and in particular to the actuator(s) 104, where the motor(s) 144 are driven at the speed corresponding to the current and thus generating a force 310, which may resist or assist motion of the vehicle body 106 providing the desired ride characteristics.

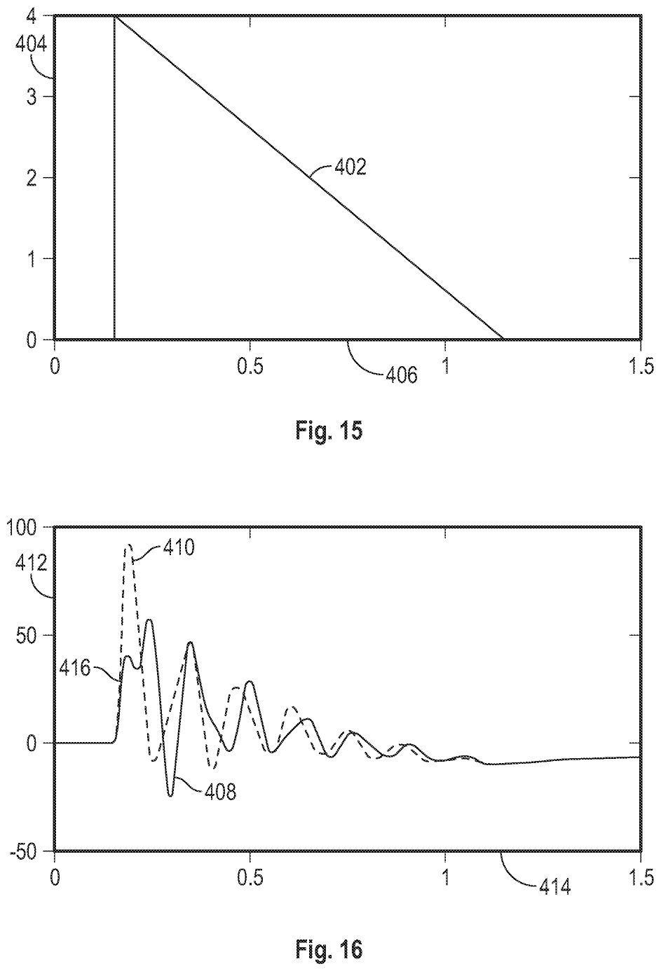

Referring to FIGS. 15 and 16, performance of the suspension system 102 is depicted. FIG. 15 illustrates a road input 402 in millimeters on the vertical axis 404 over time on the horizontal axis 406 in seconds. In this case, the road input is an impact bump of a nearly instantaneous 4 millimeters. FIG. 16 shows the responsiveness of the actuator 104 with regard to rotation of the motor 144 to resist the impact at curve 408 as compared to an ideal response 410. The vertical axis 412 depicts rotational velocity in radians per second and the horizontal axis 414 depicts time in seconds. The initial response at segment 416 of the curve 408, in particular, nearly matches the ideal response 410, with the remainder of the curve 408 being very close to the ideal response 410. FIG. 16 confirms that the actuator 104 effectively counters inputs and responds very fast.

Accordingly, a suspension system is provided for a suspended body such as that of a vehicle. In various embodiments, the suspension system includes an unsprung mass that generally receives inputs that require damping and a sprung mass that is suspended on the unsprung mass to reduce the effects of those inputs. An actuator is connected with the unsprung mass and with the sprung mass and is configured to generate forces to resist and/or assist relative movement between the sprung mass and the unsprung mass. The actuator includes an electrically conductive tube. A magnetic assembly is disposed in the tube. The actuator generates a force between the magnetic assembly and the tube in relation to velocity of the relative movement. A motor has a rotor connected with the magnetic assembly to rotate the magnetic assembly relative to the tube to provide active response characteristics.

It will be appreciated that the systems may vary from those depicted in the FIGS. and described herein. It will similarly be appreciated that the suspension system, and components and implementations thereof, may be installed in any number of different types of vehicles or other apparatus, and may vary from those depicted in the FIGS. and described in connection therewith, in various embodiments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A suspension system comprising:
a first mass;
a second mass; and
an actuator connected with the first mass and with the second mass and configured to influence a relative movement between the first mass and the second mass, the actuator comprising:
a tube;
a magnetic assembly disposed in the tube, wherein the actuator is configured to generate a force between the magnetic assembly and the tube as a result of the relative movement; and
a motor configured to rotate the magnetic assembly relative to the tube to vary the force in a velocity-dependent relationship.

2. The suspension system of claim 1, further comprising a shaft extending into the tube, wherein the motor is disposed outside the tube and is connected with the magnetic assembly through the shaft.

3. The suspension system of claim 1, wherein the magnetic assembly includes plural magnetic elements configured with polarities in alternating relation.

4. The suspension system of claim 1, wherein the magnetic element is configured to generate the force from a first force component that results from a longitudinal movement of the magnetic element relative to the tube and selectively from a second force component that results from a rotational movement of the magnetic element relative to the tube.

5. The suspension system of claim 1, wherein:
the first mass includes a vehicle body;
the second mass includes a wheel;
the tube is connected to move with the second mass; and
the magnetic element is connected to move with the first mass.

6. The suspension system of claim 5, further comprising a spring suspending the first mass on the tube.

7. The suspension system of claim 1, wherein the actuator is configured to generate the force in relation to a velocity of the relative movement independent of a position of the magnetic assembly within the tube.

8. The suspension system of claim 1, wherein the magnetic assembly generates a magnetic field that is a sole source of damping force of the actuator.

9. The suspension system of claim 1, further comprising a controller configured to:
monitor a sensor to obtain an acceleration of the first mass;
determine, from the acceleration, a desired force for the actuator; and
control delivery of current to the motor to rotate the magnetic assembly at a velocity that generates the desired force.

10. The suspension system of claim 1, wherein the actuator is configured to generate a first force at a first velocity of the magnetic assembly relative to the tube and a second force at a second velocity of the magnetic assembly relative to the tube, wherein the first velocity is slower than the second velocity and the first force has a lower magnitude than the second force.

11. The suspension system of claim 1, further comprising:
a first guide disposed in the tube on a first side of the magnetic assembly; and
a second guide disposed in the tube on a second side of the magnetic assembly;
wherein the first and second guides are configured to center the magnetic assembly in the tube.

12. A suspension system comprising:
an unsprung mass;
a sprung mass; and
an actuator connected with the unsprung mass and with the sprung mass and configured to generate force in response to a relative movement between the sprung mass and the unsprung mass, the actuator comprising:
a tube comprising an electrically conductive material;
a magnetic assembly disposed in the tube, wherein the actuator is configured to generate the force between the magnetic assembly and the tube in relation to a velocity of the relative movement; and
a motor that has a rotor connected with the magnetic assembly and that is configured to rotate the magnetic assembly relative to the tube.

13. The suspension system of claim 12, wherein the magnetic assembly includes plural magnetic elements configured in spirals that encircle the magnetic assembly to create alternate adjacent helixes with opposite polarities.

14. The suspension system of claim 12, wherein the magnetic element is configured to generate the force from a first force component that results from a longitudinal movement of the magnetic element relative to the tube and selectively from a second force component that results from a rotational movement of the magnetic element relative to the tube, wherein the first force component varies in relation to a first velocity of the longitudinal movement and the second force component varies in relation to a second velocity of the rotational movement.

15. The suspension system of claim 12, wherein:
the sprung mass includes a vehicle body;
the unsprung mass includes a wheel and a control arm;
the magnetic element is connected to the vehicle body to move with the sprung mass; and
the tube is connected to the control arm to move with the unsprung mass.

16. The suspension system of claim 15, further comprising a spring suspending the sprung mass on the tube.

17. The suspension system of claim 12, wherein the magnetic assembly generates a magnetic field that is a sole source of damping provided by the actuator.

18. The suspension system of claim 12, further comprising a controller configured to:
monitor a sensor to obtain an acceleration of the sprung mass;
determine, from the acceleration, a desired force for the actuator;
control delivery of current to the motor to rotate the magnetic assembly at a velocity that generates the desired force.

19. The suspension system of claim 12, wherein the actuator is configured to generate a first force at a first velocity of the magnetic assembly relative to the tube and a second force at a second velocity of the magnetic assembly relative to the tube, wherein the first velocity is slower than the second velocity and the first force has a lower magnitude than the second force.

20. A vehicle suspension system comprising:
a sprung mass that includes a body of the vehicle;
an unsprung mass that includes a wheel of the vehicle;
a spring suspending the sprung mass on the unsprung mass; and
an actuator connected with the sprung mass and with the unsprung mass and configured to influence a relative movement between the sprung and unsprung masses, the actuator comprising:
a tube fixed to move with the unsprung mass;
a magnetic assembly disposed in the tube and fixed to move with the sprung mass, wherein the actuator is configured to generate a force between the magnetic assembly and the tube as a result of the relative movement; and
a motor that has a rotor connected with the magnetic assembly to selectively rotate the magnetic assembly relative to the tube to vary a magnitude of the force.
